(19) United States
(12) Patent Application Publication
(10) Pub. No.: US 2025/0284908 A1
(43) Pub. Date: Sep. 11, 2025

(54) MARKING LABEL

(71) Applicant: STMicroelectronics International N.V., Geneva (CH)

(72) Inventors: Olivier LE NEEL, Saint Martin d Uriage (FR); Stephane MONFRAY, Eybens (FR)

(73) Assignee: STMicroelectronics International N.V., Geneva (CH)

(21) Appl. No.: 19/069,787

(22) Filed: Mar. 4, 2025

(30) Foreign Application Priority Data
Mar. 5, 2024 (FR) FR2402206

(51) Int. Cl. G06K 7/14; G06K 7/10; G06K 19/06

(52) U.S. Cl. CPC G06K 7/1408; G06K 19/06009; G06K 2007/10524

(57) ABSTRACT

An optical marking label includes one or more elementary cells. The elementary cells include first elementary cells which each are formed by at least one Fano resonance filter formed by a periodic structure made of a phase-change material. The elementary cells may include second elementary cells which are devoid of Fano resonance filters.

### PRIORITY CLAIM

This application claims the priority benefit of French Application for Patent No. 2402206, filed on Mar. 5, 2024, the content of which is hereby incorporated by reference in its entirety to the maximum extent allowable by law.

### TECHNICAL FIELD

The present disclosure generally concerns marking labels and, more particularly, marking labels which are passive, that is, devoid of electric power supply.

### BACKGROUND

Many types of passive marking labels, typically enabling to identify and/or to authenticate products, identity documents, credit cards, etc., to which they have been affixed, have been provided. Among existing marking labels, passive labels comprising a one-dimensional (1D) barcode, for example an EAN (European Article Numbering) barcode, a two-dimensional (2D) barcode, for example a QR (Quick Response) code or a Datamatrix code, a security hologram, etc., have in particular been provided.

However, existing marking labels have various disadvantages. Existing marking labels are, in particular, likely to be falsified, compromising in this case the authenticity and/or the security of the marked products.

There exists a need to overcome all or part of the disadvantages of existing marking labels. It would in particular be desirable to have marking labels which cannot be falsified, or are very difficult to falsify, thus enabling to guarantee the authenticity and/or to increase the security of the marked products.

### SUMMARY

In an embodiment, an optical marking label comprises one or a plurality of elementary cells, among which one or a plurality of first elementary cells each comprise at least one Fano resonance filter.

According to an embodiment, each Fano resonance filter comprises a periodic structure.

According to an embodiment, the periodic structure comprises an array of pads.

According to an embodiment, the periodic structure is made of a phase-change material.

According to an embodiment, said first elementary cell(s) each comprise a single Fano resonance filter.

According to an embodiment, the label comprises a plurality of first elementary cells with Fano resonance filters having different central frequencies.

According to an embodiment, said first elementary cell(s) each comprise a stack of at least two Fano resonance filters having different central frequencies.

According to an embodiment, said elementary cells further comprise one or a plurality of second elementary cells devoid of a Fano resonance filter.

An embodiment provides a device for reading the optical marking label such as described, the device comprising: a light sensor comprising one or a plurality of pixels arranged inside and on top of a semiconductor substrate, each pixel comprising a first photodetector comprising a Fano resonance filter, the central frequency or frequencies of the Fano resonance filter(s) of the readout device being substantially equal to the central frequency or frequencies of the Fano resonance filter(s) of the label; and a source of white light configured to illuminate the label.

According to an embodiment, each pixel of the light sensor further comprises a second photodetector devoid of a Fano resonance filter.

According to an embodiment, the light sensor further comprises at least one anode region common to a plurality of pixels.

According to an embodiment, the Fano resonance filter of the first photodetector comprises a periodic structure comprising an array of pads.

An embodiment provides a method of reading, by means of the readout device such as described, the optical marking label such as described, the method comprising the following steps: a) illuminating the label by means of the source of white light; and b) detecting, by means of the light sensor, the presence of the Fano resonance filter(s) in the label by comparison, with a reference signal, of an output signal of the photodetector of each pixel.

An embodiment provides a device for reading the optical marking label such as described, the device comprising: a visible image sensor intended to capture an image of the label; and a light source intended to illuminate the label, the light source comprising one or a plurality of elementary sources, the central emission frequency or frequencies of the elementary source(s) being substantially equal to the central frequency or frequencies of the Fano resonance filter(s) of the label.

An embodiment provides a method of reading, by means of the readout device such as described, the optical marking label such as described, the method comprising the following steps: a) illuminating the label by successively activating the elementary sources; b) capturing, by means of the visible image sensor, for each phase of illumination by one of the elementary sources, a visible image of the label; and c) detecting, based on the visible image(s), the presence and/or the position of the Fano resonance filter(s) in the label.

An embodiment provides a system comprising the label such as described and the readout device such as described.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a top view, simplified and partial, of an example of a marking label;

FIG. 2 is a side and cross-sectional view along plane AA of FIG. 1, simplified and partial, of the marking label of FIG. 1;

FIG. 3 is a top view, simplified and partial, of an example of a light sensor;

FIG. 4 is a side and cross-sectional view, simplified and partial, of the light sensor of FIG. 3;

FIG. 5 schematically and partially illustrates, in the form of blocks, an example of a marking label reading system;

FIG. 6 schematically and partially illustrates, in the form of blocks, another example of a marking label reading system; and

FIG. 7 illustrates, schematically and partially, an example of implementation of a marking label reading system.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the different applications of marking labels have not been detailed, the described embodiments being compatible with all or most applications implementing marking labels, subject to possible adaptations within the abilities of those skilled in the art based on the indications of the present disclosure.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

In the following description, the qualifiers “insulating” and “conductive” respectively signify, unless indicated otherwise, electrically insulating and electrically conductive.

The expression “transmittance of a layer” designates a ratio between an intensity of a radiation coming out of the layer and the intensity of the radiation entering the layer. In the following description, a layer is said to be opaque to a radiation when its transmittance is, for this radiation, lower than 40%, preferably lower than or equal to 25%, more preferably lower than or equal to 10%. Besides, a layer is said to be transparent to a radiation when its transmittance is, for this radiation, higher than or equal to 40%, preferably higher than or equal to 75%, more preferably higher than or equal to 90%. The above definition of opaque and transparent is not limited to the case of a layer, but more generally applies to any element likely to be exposed to a radiation, for example a substrate, a region, a stack of a plurality of layers, etc.

In the present description, the expression “Fano resonance filter” designates a filter implementing an optical phenomenon called Fano resonance, or Fano effect. In such a filter, an incident radiation, for example visible light, irradiating a dielectric periodic structure of the filter excites a surface-confined mode supported by the surface of the periodic structure. This confined, or localized, mode interferes with the radiation reflected by the surface of the periodic structure. When the localized mode and the reflected radiation have the same phase, constructive interference between the localized mode and the reflected radiation leads to the appearing of a reflected radiation peak, that is, a radiation reflection peak. Thus, there exists a wavelength at which the incident radiation irradiating the filter is reflected at more than 80% or even at more than 90%, and this wavelength determines the central frequency of the filter. A Fano resonance filter thus behaves like a notch filter, conversely, for example, to a plasmonic filter.

In the present disclosure, the term “different Fano resonance filters” is used to designate Fano resonance filters having different central frequencies.

Examples of Fano resonance filters are described in the article by Shuai, et al., entitled “Double-layer Fano resonance photonic crystal filters”, published in 2013 in Optics Express vol. 21, and in the article by Shen. et al. entitled “Structural Colors from Fano Resonances”, published in 2014 in ACS Photonics (both of which are incorporated herein by reference).

Embodiments herein provide a marking label taking advantage of the above-mentioned Fano resonance phenomenon. An optical marking label is provided comprising one or a plurality of elementary cells, wherein the or at least one of the elementary cells comprises a Fano resonance filter. A device for reading optical marking labels comprising at least one Fano resonance filter is further provided.

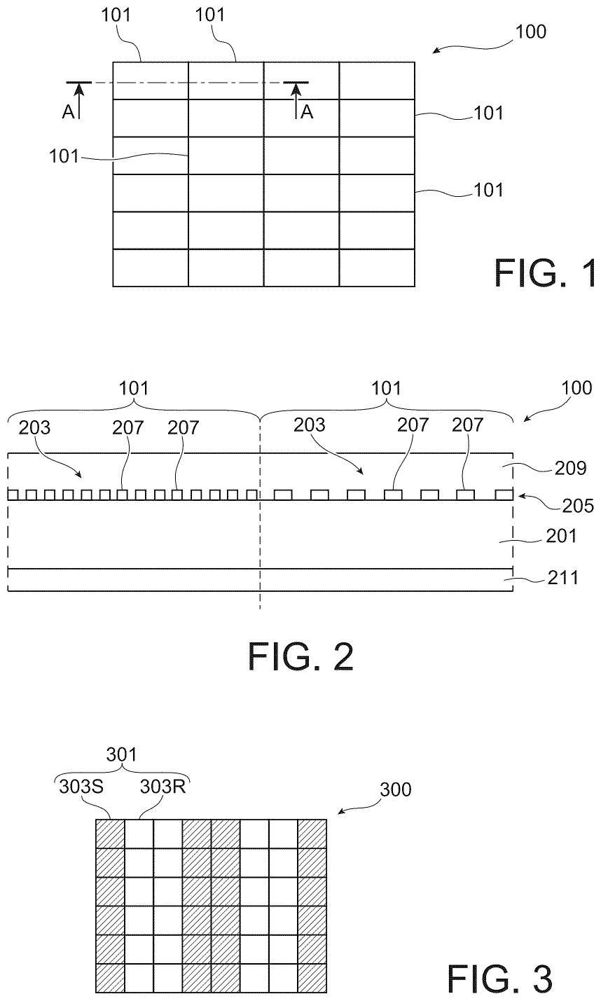

FIG. 1 is a top view, simplified and partial, of an example of a marking label 100. In the shown example, label 100 is more precisely an optical marking label. Marking label 100 is, in particular, devoid of electric power supply.

In the shown example, marking label 100 has, in top view, a substantially rectangular shape. This example is, however, non-limiting, and marking label 100 may more generally have, in top view, any shape, for example a polygonal shape other than rectangular—for example square, triangular, hexagonal, etc.—or a rounded shape—for example oval, circular, etc.

As an example, marking label 100 has a surface area in the range from 0.1 to 10 mm², for example equal to approximately 1 mm².

Marking label 100 comprises a plurality of elementary cells 101. In the example shown in FIG. 1, elementary cells 101 are arranged in the form of an array along rows and columns. FIG. 1 illustrates an example in which marking label 100 comprises twenty-four elementary cells 101 distributed in six rows and four columns. However, this example is not limiting, and marking label 100 may as a variant comprise any integer number N, greater than or equal to one, of elementary cells 101. Further, if marking label 100 comprises a plurality of elementary cells 101, these cells may be distributed in any manner within marking label 100, for example arranged in an array comprising any non-zero integer numbers of rows and columns.

In the shown example, the elementary cells 101 of marking label 100 have substantially equal lateral dimensions, to within manufacturing dispersions. Further, elementary cells 101 are, in this example, distributed with a constant pitch, that is, with a constant center-to-center distance between two adjacent elementary cells 101, along the rows and along the columns of the array of elementary cells 101.

Although FIG. 1 illustrates an example in which elementary cells 101 are adjacent, this example is not limiting and marking label 100 may, as a variant, comprise one or a plurality of spaces devoid of elementary cells 101 laterally interposed between a plurality of cells or groups of elementary cells 101. As an example, marking label 100 may, in this case, have a ring shape in which the elementary cells 101 are located in a peripheral region surrounding a blank central region, that is, a region which is devoid of elementary cells 101.

In the shown example, each elementary cell 101 of marking label 100 has, in top view, a substantially rectangular shape. This example is however not limiting, and each elementary cell 101 may more generally have, in top view, any shape, for example a polygonal shape other than rectangular—for example square, triangular, hexagonal, etc.—or a rounded shape-for example oval, circular, etc.

FIG. 2 is a side and cross-sectional view along plane AA of FIG. 1, simplified and partial, of marking label 100. FIG. 2 more specifically corresponds, for example, to a side and cross-sectional view, along a plane substantially parallel to the rows or to the columns of elementary cells 101 of marking label 100, of two adjacent elementary cells 101.

In the shown example, each elementary cell 101 comprises a support substrate 201. Support substrate 201 is, for example, made of a material transparent to visible light, for example made of glass.

According to an embodiment, at least one of the elementary cells 101 of marking label 100 comprises a Fano resonance filter 203. In the shown example, the two elementary cells 101 each comprise a Fano resonance filter 203. Each Fano resonance filter 203 comprises, for example, a periodic structure located on top of and in contact with a surface of support substrate 201 (the upper surface of support substrate 201, in the orientation of FIG. 2). The periodic structures of Fano resonance filters 203 are, for example, formed in an insulating layer 205 previously deposited on the upper surface of support substrate 201. Each periodic structure, for example, forms a metastructure, also called metasurface.

As an example, the insulating layer 205 in which the periodic structures of the Fano resonance filter 203 are formed is made of amorphous carbon, of amorphous silicon, of silicon nitride, of undoped polysilicon, or of silicon carbide.

As a variant, insulating layer 205 may be made of a phase-change material, that is, of a material capable of alternating, under the effect of a temperature variation, between a crystalline phase and an amorphous phase. The phase-change material is, for example, a “chalcogenide” material, that is, a material or an alloy comprising at least one chalcogen element, for example a material from the family of germanium telluride (GeTe), of antimony telluride (SbTe), of antimony sulfide (Sb₂S₃), of antimony selenide (Sb₂Se₃), or of germanium-antimony-telluride (GeSbTe, commonly known by the acronym “GST”). The fact that the periodic structures of the Fano resonance filters 203 of marking label 100 are made of a phase-change material enables, for example, to obtain, for a same Fano resonance filter, two different central frequencies according to whether the material of insulating layer 205 is configured in the crystalline or amorphous state.

In the shown example, each Fano resonance filter 203 comprises an array of pads 207, for example of substantially cylindrical shape with a circular cross-section. This example is, however, not limiting, and pads 207 may more generally have any shape, for example a cylindrical shape with a cross-section other than circular—for example square, triangular, hexagonal, oval, etc.—or a conical, frustoconical, pyramidal shape, etc. In top view, pads 207 are arranged in an array, for example, with a constant pitch, along rows and columns.

In order not to overload the drawing, only a few pads 207 have been symbolized in FIG. 2 for each Fano resonance filter 203. However, this example is not limiting, and each Fano resonance filter 203 may, of course, comprise a number of pads much greater than what has been shown in FIG. 2, for example several tens, several hundreds, or several thousands of pads 207.

Within a single Fano resonance filter 203, pads 207 have, for example, lateral dimensions and a pitch, that is, a center-to-center distance between two adjacent pads 207, substantially constant, to within manufacturing dispersions. The Fano resonance filters 203 of the two elementary cells 101 illustrated in FIG. 2 have different central frequencies, and thus different rejection bands. In the illustrated example, the pads 207 of the Fano resonance filter 203 of the left-hand elementary cell 101 have lateral dimensions and a pitch different from those of the pads 207 of the Fano resonance filter 203 of the right-hand elementary cell 101. This example is however not limiting, and the difference in central frequencies between two Fano resonance filters 203 may, as a variant, be obtained by modifying only the lateral dimensions or only the pitch of pads 207, to within manufacturing dispersions.

Each pad 207, for example, has a maximum lateral dimension—for example, a diameter, in the case where pads 207 are cylindrical—in the range from 100 to 600 nm. Further, the pitch of the array of pads 207 is, for example, in the range from 200 to 700 nm.

An example of embodiment of marking label 100 in which the periodic structure of each Fano resonance filter 203 comprises pads has been detailed hereabove. This example is however not limiting.

As a variant, the periodic structures of the Fano resonance filters 203 may each comprise a plurality of concentric rings made of an insulating material, for example selected from the materials listed hereabove for insulating layer 205. In this case, the width and/or the pitch of the rings, that is, the distance separating the median circles of two adjacent rings, enable to define the central frequency of filter 203.

As a variant, the periodic structures of the Fano resonance filters 203 may each comprise a plurality of vias or of cavities, for example of substantially cylindrical shape with a circular cross-section, formed in insulating layer 205. This example is, however, not limiting, and the vias may more generally have any shape, for example a cylindrical shape with a cross-section other than circular—for example square, triangular, hexagonal, oval, etc.—or a conical, truncated cone shape. In this variant, the vias are, for example, arranged in an array, with a constant pitch, in rows and columns, the lateral dimensions and/or the pitch of the holes, that is, the center-to-center distance between two adjacent holes, enabling to define the central frequency of filter 203.

In the shown example, the periodic structure of the Fano resonance filters 203 is defined by openings, or cavities, running across the entire thickness of insulating layer 205. However, this example is not limiting. As a variant, the periodic structure of each Fano resonance filter 203 may be defined by openings which do not run through insulating layer 205, for example openings extending in insulating layer 205 from a surface of layer 205 intended to be irradiated with a radiation (the upper surface of insulating layer 205, opposite to support substrate 201, in the orientation of FIG. 2) and interrupted in the thickness of layer 205. In this variant, the openings penetrate into insulating layer 205, for example, across substantially half of its thickness. Similarly, in the variants described hereabove where the periodic structures of the Fano resonance filters 203 comprise concentric rings or vias, the openings separating the rings or the openings forming the vias may by through or not.

In the illustrated example, each Fano resonance filter further comprises another insulating layer 209 coating insulating layer 205. Insulating layer 209 more specifically coats the side surfaces and the upper surface of pads 207. Insulating layer 209 is, for example, located on top of and in contact with the side surfaces and the upper surface of pads 207 and fills, that is, integrally fills, all the free spaces laterally extending between pads 207. Insulating layer 209 is made of a material different from that of pads 207. As an example, insulating layer 209 is made of silicon oxide or of silicon nitride.

Marking label 100 is, for example, intended to be illuminated by a radiation, for example visible light, on the side of the surface of support substrate 201 supporting the Fano resonance filter(s) 203. Although this has not been detailed in the drawings, the marking label is, for example, intended to be mechanically affixed to a substrate. For this purpose, an adhesive layer (not shown) may, for example, be provided on the side of a surface of the support substrate 201 opposite to its surface supporting the Fano resonance filter(s) 203.

Each elementary cell 101 further comprises, for example, an anti-reflection layer 211 coating a surface of support substrate 201 opposite to the Fano resonance filter 203 (the lower surface of support substrate 201, in the orientation of FIG. 2). In the illustrated example, anti-reflection layer 211 is located on top of and in contact with the lower surface of support substrate 201. As an example, anti-reflection layer 211 extends laterally in continuous manner over the entire lower surface of support substrate 201. Anti-reflection layer 211 has the function of avoiding for the incident radiation irradiating marking label 100, for example the visible light illuminating label 100, to be reflected after having crossed the Fano resonance filter(s) 203. In the case where an adhesive layer is provided to affix marking label 100 to a substrate, the adhesive layer coats, for example, a surface of anti-reflection layer 211 opposite to support substrate 201 (the lower surface of anti-reflection layer 211, in the orientation of FIG. 2).

Although this has not been detailed in FIGS. 1 and 2, each of the other elementary cells 101 of marking label 100 may either comprise a Fano resonance filter 203, or be devoid of a Fano resonance filter. As an example, in elementary cell(s) 101 devoid of a Fano resonance filter, insulating layer 205 is continuous and extends laterally over the entire surface of elementary cell 101. As a variant, insulating layer 205 is omitted in elementary cell(s) 101 devoid of a Fano resonance filter.

FIG. 2 illustrates an example in which at least two of the elementary cells 101 of marking label 100 each comprise Fano resonance filter 203. However, this example is not limiting. More generally, at least one of the elementary cells 101 of marking label 100 comprises Fano resonance filter 203, while the other cells 101 of label 100 may be either provided with or devoid of Fano resonance filter 203.

Marking label 100 comprises, for example, a non-zero integer number N, for example greater than or equal to two, of elementary cells 101 (N=24 in the example illustrated in FIG. 1). In this example, at least one of cells 101 and at most the N cells 101 comprise Fano resonance filter 203.

The central frequency of each Fano resonance filter 203 of label 100 is, for example, selected from a non-zero integer number C of possible central frequencies. As an example, the number C of possible central frequencies for each of the Fano resonance filters 203 is equal to the number N of elementary cells 101 of label 100. This example is, however, not limiting, and the number C may, as a variant, be different from number N, for example greater than number N.

As an example, the Fano resonance filters 203 of the elementary cells 101 of marking label 100 which are provided therewith have different central frequencies. As a variant, a plurality of Fano resonance filters 203 of marking label 100 may have substantially equal central frequencies.

By choosing, for each of the N elementary cells 101 of marking label 100, to integrate or not the Fano resonance filter 203, and by varying the central frequency of this filter from one cell to another, it is possible to obtain different configurations for label 100.

As an example, if all the Fano resonance filters 203 have different central frequencies (C≥N), and without taking into account the position in marking label 100 of the elementary cells 101 comprising Fano resonance filter 203, label 100 has 2^{N}−1 different possible configurations. In the example where label 100 comprises twenty-four elementary cells 101 (N=24), there are approximately sixteen million different possible configurations for label 100.

More generally, the number of possible configurations for marking label 100 can be adjusted: by modifying the total number of elementary cells 101 that label 100 comprises; by allowing, or not, for a plurality of Fano resonance filters 203 of label 100 to have the same central frequency; and/or by taking into account, or not, the position of the cells 101 comprising Fano resonance filter 203 in label 100.

In particular, the fact of allowing for a plurality of Fano resonance filters 203 to have the same central frequency and/or the fact of taking into account the position, in marking label 100, of the elementary cells 101 provided with Fano resonance filter 203 enables to increase the number of different possible configurations for label 100. Those skilled in the art are capable, based on the indications of the present disclosure, of adjusting the above parameters according to the application, in particular according to the number of different possible configurations desired for marking label 100.

Although this has not been detailed in the drawings, each elementary cell 101 may, as a variant, comprise a stack comprising at least two Fano resonance filters, for example similar or identical to filter 203, having different central frequencies. In the case where the position of the elementary cells 101 comprising Fano resonance filter 203 in marking label 100 is not taken into account, this enables, for example, as compared with the shown example where elementary cells 101 comprise a single Fano resonance filter, to decrease the lateral dimensions of marking label 100 while keeping the same number of different possible configurations for label 100. In the case where the position of the elementary cells 101 comprising Fano resonance filter 203 in marking label 100 is taken into account, this enables, for example, as compared with the example shown where the elementary cells 101 comprise a single Fano resonance filter, to increase the number of different possible configurations for label 100.

FIG. 3 is a top view, simplified and partial, of an example of a light sensor 300 according to an embodiment.

In the shown example, light sensor 300 comprises a plurality of pixels 301. In the example shown in FIG. 3, pixels 301 are organized in the form of an array along rows and columns. FIG. 3 illustrates an example in which light sensor 300 comprises twenty-four pixels 301 arranged in six rows and four columns. This example is, however, not limiting, and light sensor 300 may as a variant comprise any integer number M, greater than or equal to one, of pixels 301. Further, in the case where light sensor 300 comprises a plurality of pixels 301, these pixels may be distributed in any way within light sensor 300, for example arranged in an array comprising any non-zero integer numbers of rows and columns. As a variant, light sensor 300 may comprise a single pixel 301, for example in a case where label 100 comprises a single elementary cell 101 comprising Fano resonance filter 203.

The number M of pixels 301 is greater than or equal to the number C of different central frequencies possible for the Fano resonance filters 203 of marking label 100. As an example, the number M of pixels 301 of light sensor 300 is equal to the number N of elementary cells 101 of marking label 100. This example is, however, not limiting, and the number M of pixels 301 may, as a variant, be different from the number N of elementary cells 101 of marking label 100, for example greater than number N.

In the shown example, the array of pixels 301 of light sensor 300 has, in top view, a substantially rectangular shape. This example is, however, not limiting, and pixel array 301 may more generally have, in top view, any shape, for example a polygonal shape other than rectangular—for example square, triangular, hexagonal, etc.—or a rounded shape—for example oval, circular, etc. The shape of the array of pixels 301 is, for example, substantially identical to that of marking label 100.

Further, in the shown example, each pixel 301 of light sensor 300 has, in top view, a substantially rectangular shape. This example is however not limiting, and each pixel 301 may more generally have, in top view, any shape, for example a polygonal shape other than rectangular—for example square, triangular, hexagonal, etc.—or a rounded shape—for example oval, circular, etc. The pixels 301 of light sensor 300 may have lateral dimensions different from those of the elementary cells 101 of marking label 100.

In the shown example, the pixels 301 of light sensor 300 have substantially equal lateral dimensions, to within manufacturing dispersions. Further, in this example, the pixels 301 are distributed with a constant pitch, that is, with a constant center-to-center distance between two adjacent pixels 301, along the rows and along the columns of the array of pixels 301.

Each pixel 301 of light sensor 300 for example comprises a pair of photodetectors 303S and 303R, for example photodiodes. As an example, photodetector 303S is a detection photodetector and photodetector 303R is a reference photodetector. Photodetectors 303S and 303R are for example adapted to capturing visible light. The structure and the role of each photodetector 303R, 303S are discussed in further detail hereafter.

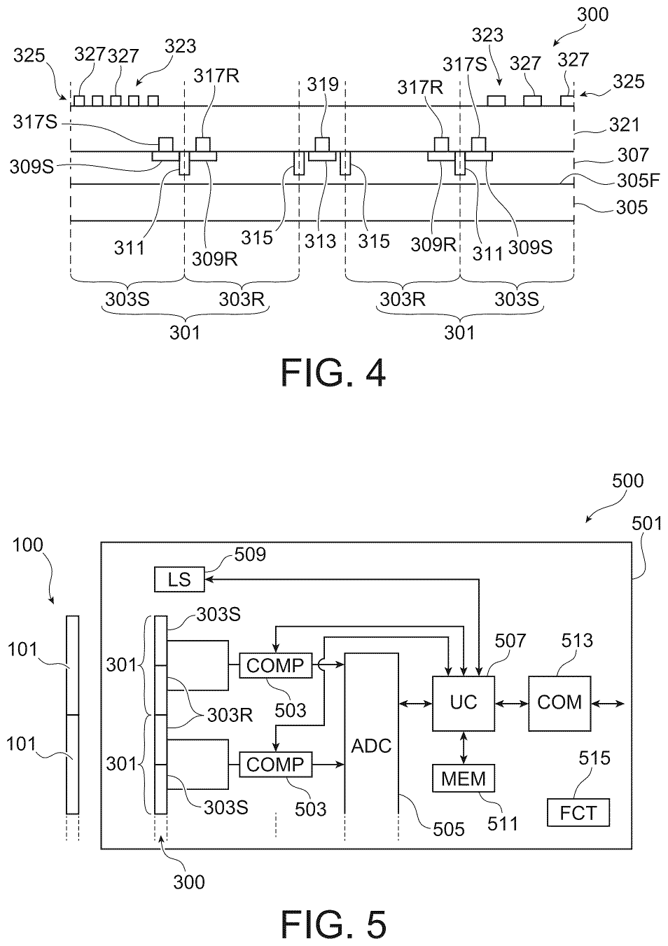

FIG. 4 is a side and cross-sectional view, simplified and partial, of light sensor 300. FIG. 3 more specifically corresponds, for example, to a side and cross-sectional view, along a plane substantially parallel to the pixel lines 301 of light sensor 300, of two adjacent pixels 301.

In the shown example, pixels 301 are arranged inside and on top of a semiconductor substrate 305. Semiconductor substrate 305 is, for example, a wafer or a piece of wafer, for example made of silicon. Semiconductor substrate 305 is doped with a first conductivity type, for example type P. In the illustrated example, pixels 301 are more specifically arranged on the side of a front surface 305F of semiconductor substrate 305 (the upper surface of substrate 305, in the orientation of FIG. 4). The front surface 305F of semiconductor substrate 305 is, for example, intended to receive visible light.

In the illustrated example, light sensor 300 comprises a semiconductor layer 307 coating semiconductor substrate 305. Semiconductor layer 307 extends, for example, laterally and continuously on top of and in contact with the entire front surface 305F of semiconductor substrate 305. Semiconductor layer 307 is, for example, made of the same material as semiconductor substrate 305. Semiconductor layer 307 is, for example, doped with the same conductivity type as semiconductor substrate 305 (type P, in this example) and has, for example, a doping level lower than that of semiconductor substrate 305. As an example, semiconductor layer 307 is formed by epitaxial growth from surface 305F of semiconductor substrate 305.

In the shown example, each photodetector 303R, 303S comprises a cathode region 309R, 309S formed in semiconductor layer 307. Each cathode region 309R, 309S extends, for example, in semiconductor layer 307 from a surface of semiconductor layer 307 opposite to semiconductor substrate 305 (the upper surface of layer 307, in the orientation of FIG. 4) down to a depth smaller than the thickness of semiconductor layer 307. Cathode regions 309R and 309S are, for example, doped with a conductivity type opposite to that of semiconductor layer 307 (type N, in this example).

In the shown example, an insulating region 311 is laterally interposed between the cathode regions 309R and 309S of each pixel 301. In the shown example, insulating region 311 extends in semiconductor layer 307 from the upper surface of semiconductor layer 307 down to a depth greater than that of cathode regions 309R and 309S, and smaller than the thickness of semiconductor layer 307. As an example, insulating region 311 is an insulating trench.

In the shown example, an anode region 313 is formed in semiconductor layer 307. Anode region 313 extends, for example, in semiconductor layer 307 from the upper surface of semiconductor layer 307 down to a depth smaller than the thickness of the semiconductor layer 307. In the example illustrated in FIG. 4, anode region 313 is located substantially at the center of the two shown pixels 301. Anode region 313 is, for example, doped with the same conductivity type as that of semiconductor layer 307 (type P, in this example). In the illustrated example, anode region 313 is common to the photodetectors 303S, 303R of the two pixels 301.

FIG. 4 illustrates an example in which anode region 313 is shared by, or placed in common between, two adjacent pixels 301. This example is however not limiting. As a variant, each pixel 301 may have an anode region 313 distinct from the anode regions of the other pixels 301 of light sensor 300, or the same anode region 313 may be common to a number of pixels 301 different from two, for example common to a group of four pixels 301.

In the illustrated example, anode region 313 is surrounded by an insulating region 315 having for example, in top view, a ring shape. In the shown example, insulating region 315 extends in semiconductor layer 307 from the upper surface of semiconductor layer 307 down to a depth greater than that of cathode regions 309R and 309S, and smaller than the thickness of semiconductor layer 307. Insulating region 315 has, for example, a height substantially equal to that of insulating region 311. In the illustrated example, insulating region 315 is laterally separated from anode region 313 by a portion of semiconductor layer 307. As an example, insulating region 315 is an insulating trench.

In the shown example, light sensor 300 further comprises cathode electrodes 317S and 317R located on top of and in contact with cathode regions 309S and 309R, respectively. Similarly, an anode electrode 319 is located on top of and in contact with anode region 313. As an example, cathode electrodes 317S and 317R and anode electrode 319 are made of a conductive material, for example a metal or a metal alloy.

In the illustrated example, light sensor 300 further comprises an insulating layer 321 coating the surface of semiconductor layer 307 opposite to semiconductor substrate 305 (the upper surface of layer 307, in the orientation of FIG. 4). In this example, insulating layer 321 is more specifically located on top of and in contact with the upper surface of layer 307 and with the side and upper surfaces of cathode electrodes 317S, 317R and anode electrodes 319. As an example, insulating layer 321 is made of silicon oxide, of silicon nitride, or of tetraethyl orthosilicate (TEOS).

In the shown example, photodetectors 303S each comprise a Fano resonance filter 323. The Fano resonance filters of the photodetectors 303S of light sensor 300 are, for example, similar or identical to the Fano resonance filters 203 of marking label 100. In particular, each Fano resonance filter 323 comprises a periodic structure formed in an insulating layer 325. As an example, the periodic structures of the Fano resonance filters 323 of light sensor 300 each comprise an array of pads 327 similar or identical to the pads 207 of the Fano resonance filters 203 of marking label 100. As a variant, the periodic structures of the Fano resonance filters 323 of light sensor 300 may each comprise concentric rings or a network of vias as discussed in further detail hereafter in relation with FIG. 2 for Fano resonance filters 203.

In the shown example, photodetectors 303R are devoid of Fano resonance filter 323. In photodetectors 303R, insulating layer 325 is, for example, omitted, as in the example illustrated in FIG. 4, or extends laterally and continuously over the entire surface of insulating layer 321 opposite to semiconductor substrate 305.

FIGS. 3 and 4 illustrate an example in which photodetectors 303R are placed side by side along a same line of pixels 301. In this example, each line of pixels 301 is, for example, formed by repetition of an elementary pattern consisting of two photodetectors 303S located on either side of two adjacent photodetectors 303R. This enables, for example, as previously discussed in relation with FIG. 4, to share the anode region 313 of photodetectors 303R and 303S forming part of the two pixels 301 of each pair. This example is however not limiting. As a variant, each line of pixels 301 may be formed by repetition of an elementary pattern comprising a photodetector 303R and an adjacent photodetector 303S. This corresponds, for example, to the case where the anode region of the photodetectors 303R and 303S of a same 301 pixel is distinct from the anode regions of the photodetectors 303R and 303S of the other pixels 301.

Although this has not been detailed in FIG. 4, light sensor 300 may further comprise other elements, for example an anti-reflection layer interposed between semiconductor substrate 305 and the Fano resonance filters 323, an optical device configured so that light reaches the Fano resonance filters 323 under a normal incidence, optical isolation walls laterally separating photodetectors 303R and 303S, etc.

Each photodetector 303S is configured to receive, in a photosensitive area located in semiconductor layer 307, light to be analyzed having all the operating wavelengths of light sensor 300 except for those which are located in the rejection band of the Fano resonance filter 323 that it comprises. Further, each photodetector 303R is configured to receive, in a photosensitive area located in semiconductor layer 307, light to be analyzed having all the operating wavelengths of sensor 300. For each of photodetectors 303S and 303R, a readout circuit (not illustrated in FIG. 4) delivers, for example, an output signal representative of the quantity of light to be analyzed received by the photodetector. Thus, the output signal of the photodetectors 303S comprising Fano resonance filter 323 is representative of the proportion of light to be analyzed having all the operating wavelengths of the sensor except for those which are located within the rejection band of Fano resonance filter 323. Similarly, the output signal of the photodetectors 303R devoid of a Fano resonance filter is representative of the total proportion of light to be analyzed having all the operating wavelengths of sensor 300.

As an example, light sensor 300 comprises, for each central frequency of the Fano resonance filter(s) 203 likely to be present in marking label 100, at least one photodetector 303S having its Fano resonance filter 323 exhibiting a central frequency substantially equal, to within manufacturing dispersions, to that of the Fano resonance filter 203 of label 100. In this case, image sensor 300 for example comprises a number P of different Fano resonance filters 323 greater than or equal to the number C of different Fano resonance filters 203 of marking label 100, the central frequencies of the different Fano resonance filters 323 of light sensor 300 being, for example, respectively equal, to within manufacturing dispersions, to those of the Fano resonance filters 203 of marking label 100. This thus enables light sensor 300 to be capable of detecting the presence of all the different Fano resonance filters 203 likely to be present in marking label 100. As a variant, light sensor 300 may be adapted to detecting only some of the Fano resonance filters 203 among the different Fano resonance filters 203 likely to be present in marking label 100.

The detection, by light sensor 300, of the presence of the Fano resonance filters 203 in marking label 100 is discussed in further detail hereafter.

FIGS. 3 and 4 illustrate an example in which light sensor 300 comprises as many photodetectors 303R as photodetectors 303S. This example is however not limiting. As a variant, light sensor 300 may comprise a number of photodetectors 303R which is smaller than the number of photodetectors 303S. In this case, sensor 300 comprises, for example, two or four times fewer photodetectors 303R than photodetectors 303S, or even a single photodetector 303R.

FIG. 5 schematically and partially illustrates, in the form of blocks, an example of a system 500 for reading marking labels, for example the marking label 100 of FIGS. 1 and 2, according to an embodiment. In particular, FIG. 5 illustrates a case in which the reading system takes no account of the position, in marking label 100, of the elementary cells 101 comprising the Fano resonance filter 203.

In the shown example, reading system 500 comprises a readout device 501 comprising light sensor 300. Light sensor 300 is, for example, intended to be positioned in front of marking label 100.

In the illustrated example, readout device 501 comprises comparators 503 (COMP). In this example, each comparator 503 is coupled, preferably connected, to the pair of photodetectors 303R, 303S of a same pixel 301. Each comparator 503 is, for example, configured to deliver a signal or information representative of the proportion of the light to be analyzed having wavelengths located within the rejection band of the Fano resonance filter 323 of the photodetector 303S to which it is coupled, or connected, based on the output signals of the photodetectors 303S and 303R of pixel 301. To achieve this, comparator 503 is configured, for example, to subtract the value of the output signal of photodetector 303R, or reference signal, for example a current I_{R}, from the value of the output signal of photodetector 303S, for example a current Is. The result of this subtraction (I_{R}-I_{S}) is then representative of the proportion, or quantity, of light to be analyzed having wavelengths within the rejection band of the Fano resonance filter 323 of the considered pixel 301. This thus enables readout device 501 to detect, for each pixel 301 of light sensor 300, whether at least one of the elementary cells 101 of marking label 100 comprises a Fano resonance filter 203 having its central frequency substantially equal to that of the Fano resonance filter 323 of the considered pixel 301.

Although this has not been shown in FIG. 5, a current amplifier may be provided between each photodetector 303S or 303R and the associated comparator 503.

As an example, readout device 501 is configured to apply a first correction factor to the value of the output signal of photodetector 303S and/or a second correction factor to the value of the output signal of photodetector 303R before subtracting them. The correction factor(s) is (are) determined, for example, after a step of calibration of light sensor 300, for example in order to take into account, outside of the rejection band of the Fano resonance filter 323 of photodetector 303S, differences in light transmission and/or in order to take into account manufacturing dispersions, for example surface differences, between the photosensitive areas of photodetectors 303S and 303R. As an example, the correction factor(s) are stored in a memory, for example a non-volatile memory, of readout device 501. The implementation of the calibration step is within the abilities of those skilled in the art based on the indications of the present disclosure.

Further, readout device 501 is configured, for example, to normalize the values of the output signals I_{S} and I_{R} of photodetectors 303S and 303R with respect to the value of the output signal IR of photodetector 303R. The normalization step is carried out, for example, after having applied a correction factor to the value of the output signal I_{S} of photodetector 303S and/or a correction factor to the value of the output signal I_{R} of photodetector 303R, or may be followed by a step of application of a first correction factor to the normalized output value of photodetector 303S and/or a second correction factor to the normalized output value of photodetector 303R. The correction factors are determined, for example, as previously discussed.

As an example, noting λₘᵢₙ and λₘₐₓ as the minimum and maximum operating wavelengths, respectively, of light sensor 300 and noting λSₘᵢₙ and λSₘₐₓ as the lower and upper wavelengths, respectively, of the rejection band of Fano resonance filter 323, for example the −3 dB rejection band of filter 323, the photosensitive area of photodetector 303S receives light to be analyzed having wavelengths in the range from λₘᵢₙ to λSₘᵢₙ and from λSₘₐₓ to λₘₐₓ, while the photosensitive area of photodetector 303R receives light to be analyzed having wavelengths in the range from λₘᵢₙ to λₘₐₓ. Thus, output signal I_{S} representative of the quantity of light to be analyzed received by the photosensitive area of photodetector 303S for wavelengths in the range from λₘᵢₙto λSₘᵢₙ and from λSₘₐₓ to λₘₐₓ, output signal I_{R} being representative of the light to be analyzed received by the photosensitive area of photodetector 303R for wavelengths in the range from λₘᵢₙto λₘₐₓ. Light sensor 300 then delivers, for example, information representative of the proportion of the light to be analyzed received by the sensor 300 which has the wavelengths in the range from λSₘᵢₙ to λSₘₐₓ, for example by subtracting the value of the output signal I_{S} of photodetector 303S from that of the output signal I_{R} of photodetector 303R.

As an example, when light sensor 300 comprises a plurality of photodetectors 303S with Fano resonance filters 323 having different central frequencies, sensor 300 is used to obtain information representative of the spectral distribution of light between different wavelength ranges, each corresponding to a rejection band of a Fano resonance filter 323. Sensor 300 is thus, for example, an ambient light sensor (ALS). By analyzing the information representative of the spectral distribution of light, light sensor 300 enables to detect the presence or the absence, in marking label 100, of the various Fano resonance filters 203 that it is likely to contain.

As an example, for each pixel 301 of light sensor 300, the result of the subtraction of the value of the output signal I_{S} of photodetector 303S from that of the output signal I_{R} of photodetector 303R is compared with a threshold. In the case where the result is greater than or equal to the threshold, it is considered, for example, that marking label 100 comprises at least one elementary cell 101 having its Fano resonance filter 203 exhibiting a central frequency substantially equal to that of the Fano resonance filter 323 of the photodetector 303S of the considered pixel 301. However, if the result is lower than the threshold, marking label 100 is considered to contain no elementary cell 101 having its Fano resonance filter 203 exhibiting a central frequency substantially equal to that of the Fano resonance filter 323 of the photodetector 303S of the considered pixel 301.

Thus, marking label 100 may, depending on the different Fano resonance filters 203 that it comprises, be used to encode information, and light sensor 300 may be used to decode this information. As an example, in the case where the position of the Fano resonance filters 203 in marking label 100 is not taken into account, the C different Fano resonance filters 203 may be respectively associated with different binary weights, the presence or the absence of each filter being, for example, respectively associated, arbitrarily, with binary values 1 and 0. As an example, in a case where the different Fano resonance filters 203 of marking label 100 respectively correspond to distinct wavelength ranges of the visible light spectrum, the largest wavelength ranges correspond, for example, to most significant bits, while the smallest wavelength ranges correspond, for example, to least significant bits.

More generally, those skilled in the art will be capable, based on the indications of the present disclosure, of encoding a data item in marking label 100 and of implementing light sensor 300 to decode a data item contained in a marking label of the type of label 100.

In the shown example, readout device 501 further comprises an analog-to-digital converter 505 (ADC) having the outputs of comparators 503 connected thereto. Converter 505 is configured, for example, to deliver a digital detection signal indicating, for each pixel 301 of light sensor 300, whether marking label 100 comprises a Fano resonance filter 203 having its central frequency substantially equal to that of the Fano resonance filter 323 of the photodetector 303S of the considered pixel 301.

In the illustrated example, analog-to-digital converter 505 is connected to a control circuit 507 (UC), for example a microcontroller of readout device 501. Control circuit 507 is, for example, configured to control light sensor 300 and to receive the output signal of analog-to-digital converter 505.

In the shown example, control circuit 507 is further connected to a light source 509 (LS). Light source 509 is, for example, configured to illuminate marking label 100, for example with white light. As an example, light source 509 comprises at least one light-emitting diode, for example a first light-emitting diode predominantly emitting red light, a second light-emitting diode predominantly emitting green light, and a third light-emitting diode predominantly emitting blue light. In this case, the first, second, and third light-emitting diodes of light source 509 are, for example, simultaneously turned on during a phase of illumination of marking label 100.

In the illustrated example, readout device 501 further comprises a memory circuit 511 (MEM) connected to control circuit 507. Memory circuit 511 enables, for example, to store operating parameters of readout device 501, for example the correction factors determined during the step of calibration of light sensor 300.

In the shown example, readout device 501 further comprises a communication interface 513 (COM). Communication interface 513 enables, for example, readout device 501 to exchange data, information, or signals with other elements or systems, not detailed in FIG. 5.

Although this has not been detailed, readout device 501 may further comprise other elements and/or circuits symbolized, in FIG. 5, by a functional block 515 (FCT).

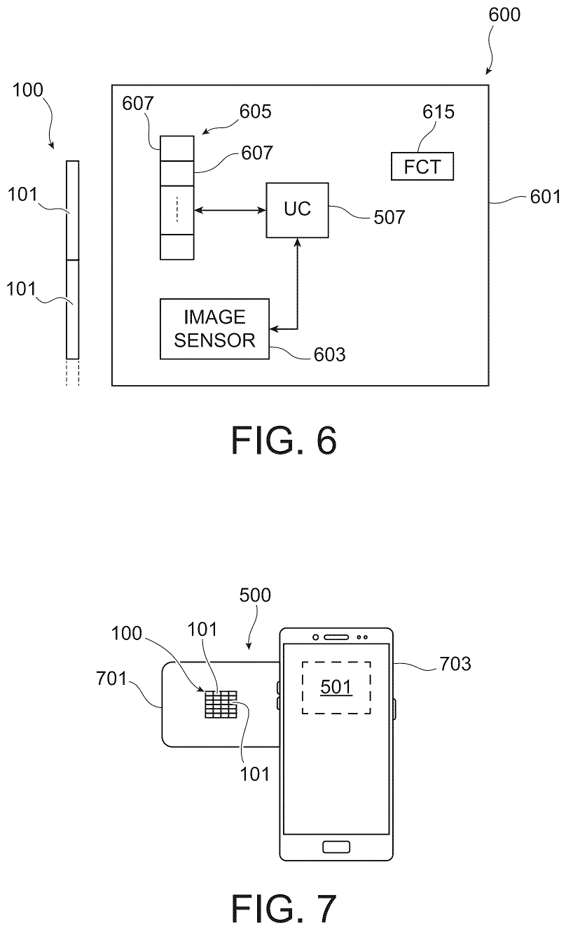

FIG. 6 schematically and partially illustrates, in the form of blocks, another example of a system 600 for reading marking labels, such as the marking label 100 of FIGS. 1 and 2. In particular, the reading system 600 of FIG. 6 differs from the reading system 500 of FIG. 5 in that reading system 600 takes into account the position, in marking label 100, of the elementary cells 101 comprising the Fano resonance filter 203.

In the shown example, reading system 600 comprises a readout device 601 comprising an image sensor 603 (IMAGE SENSOR). Image sensor 603 is, for example, intended to be positioned in front of marking label 100. Image sensor 603 is, for example, adapted to forming visible images of marking label 100. As an example, image sensor 603 is a color image sensor. As a variant, image sensor 603 may be a monochrome sensor.

In the illustrated example, readout device 601 further comprises a light source 605. In this example, light source 605 comprises, for each of the different Fano resonance filters 203 likely to be present in marking label 100, at least one elementary source 607, for example a light-emitting diode, having a central emission frequency substantially equal, to within manufacturing dispersions, to the central frequency of the Fano resonance filter 203 of label 100. In this case, light source 605 comprises, for example, a number K of different elementary sources 607 greater than or equal to the number C of different Fano resonance filters 203 of marking label 100, the central frequencies of the different elementary sources 607 of light source 605 being, for example, respectively equal, to within manufacturing dispersions, to those of the Fano resonance filters 203 of marking label 100. This thus enables reading system 600 to be capable of detecting the presence of all the different Fano resonance filters 203 likely to be present in marking label 100. As a variant, reading system 600 may be adapted to detecting only part of the Fano resonance filters 203 among the different Fano resonance filters 203 likely to be present in marking label 100.

In the shown example, readout device 601 further comprises control circuit 507 (UC). Control circuit 507 is, in readout device 601, connected to visible image sensor 603 and to light source 605. Control circuit 507 is, for example, configured to successively activate the different elementary sources 607 of light source 605 and to capture, by means of image sensor 603, a visible image of marking label 100 at each phase of illumination by one of the elementary sources 607. During each illumination phase, marking label 100 is, for example, shielded from ambient light so that marking label 100 is illuminated only, or predominantly, by the light generated by the corresponding elementary source 607.

As an example, for each visible image acquired by image sensor 603, the presence of at least one light region surrounded by a dark region indicates the presence and the position, in marking label 100, of at least one elementary cell 101 with a Fano resonance filter 203 having a central frequency substantially equal to the central emission frequency of the elementary source 607 used to acquire the image. Further, the absence of a light region in each visible image acquired by image sensor 603 indicates the absence, in marking label 100, of one or a plurality of elementary cells 101 with a Fano resonance filter 203 having a central frequency substantially equal to the central emission frequency of the elementary source 607 used to acquire the image.

Similarly to reading system 500, reading system 600 enables to encode a data item in marking label 100 and to use readout device 601 to decode this data item. Reading system 600 however has the additional advantage of allowing the taking into account of the position of the Fano resonance filter(s) 203 in marking label 100 to encode the data.

As a variant, readout device 601 may be used to detect the presence only, in marking label 100, of at least one elementary cell 101 with a Fano resonance filter 203 having a central frequency substantially equal to the central emission frequency of the elementary source 607 used to acquire the image. In this variant, the position of the Fano resonance filter(s) in marking label 100 is not taken into account.

Although this has not been detailed in FIG. 6, readout device 601 may further comprise other elements and/or circuits, for example a memory circuit similar or identical to the memory circuit 511 of device 501, a communication interface similar or identical to the communication interface 513 of readout device 501, etc. These elements and/or circuits have been symbolized in FIG. 6 by a functional block 615 (FCT).

FIG. 7 illustrates, schematically and partially, an example of implementation of a system for reading a marking label, for example the system 500 for reading marking label 100, according to an embodiment.

In the shown example, marking label 100 is affixed to a card 701, for example a bank card, an identity card, a personal identification card, a transport card, etc. This example is however not limiting, and marking label 100 may, as a variant, be affixed to any type of support, device, or product, for example a fashion item, such as a garment or a handbag, an electronic device, a passport, a banknote, a driving license, a card for accessing a secure area, a critical spare part, for example in the field of motor vehicles or of avionics, an ink cartridge for a printer, etc.

In the illustrated example, the readout device 501 of reading system 500 is integrated in a cell phone 703. In this case, the light source 509 of readout device 501 corresponds, for example, to a light source of cell phone 703 used as a flash, in combination with a visible image sensor (not detailed) of the cell phone 703, or as a torch lamp. Further, light sensor 300 corresponds in this case, for example, to an ambient light sensor of cell phone 703.

FIG. 7 illustrates a case in which readout device 501 is integrated in a cell phone. This example is, however, not limiting, and readout device 501 may, as a variant, be integrated in other electronic devices such as a touch-sensitive tablet, a laptop, a device specifically dedicated to reading marking labels of the type of label 100, etc. Further, although FIG. 7 illustrates an example of the implementation of reading system 500, this example is not limiting and those skilled in the art are capable, based on the indications of the present disclosure, of integrating reading system 600 into various types of devices, for example selected from among the above-mentioned examples. Those skilled in the art are in particular capable of substituting the readout device 501 of reading system 500 with the readout device 601 of reading system 600 in cell phone 703. In this case, the image sensor 603 of readout device 601 corresponds, for example, to a visible image sensor of cell phone 703. The integration of readout device 501 into cell phone 703 is, for example, easier than the integration of readout device 601, since advantage can be taken of the presence of components already existing in cell phone 703 to implement the functions implemented by readout device 501.

The use of Fano resonance filters in the marking label and/or in the associated readout device enables to have marking labels and/or readout devices very difficult to falsify, since Fano resonance filters are formed by complex and expensive microelectronic equipment. This enables to guarantee the authenticity and/or to reinforce the security of marked products. It is indeed unlikely that an individual, or a small group of individuals, would manage to gather the technical means required to manufacture the marking labels and/or the readout devices of the present disclosure.

Various embodiments and variants have been described. Those skilled in the art will understand that certain features of these various embodiments and variants may be combined, and other variants will occur to those skilled in the art. In particular, although examples of reading systems 500 and 600 have been detailed in relation with FIGS. 5 and 6, the embodiments are not limited to these examples and those skilled in the art are capable, based on the indications of the present disclosure, of providing reading systems different from those detailed, in particular readout devices different from those detailed.

Finally, the practical implementation of the described embodiments and variants is within the abilities of those skilled in the art based on the functional indications given hereabove. In particular, those skilled in the art are capable, based on the indications of the present disclosure, of adapting marking label 100 to the coding of different information or data, for example information linked to a product—such as a serial number, a brand name, or an item reference—to an authenticity control, etc.

Further, those skilled in the art are capable, based on the indications of the present disclosure, of defining the pitch and the lateral dimensions of the periodic structures of Fano resonance filters to obtain the desired central wavelengths. Further, the forming of light source 605, in particular of elementary sources 607, is within the abilities of those skilled in the art based on the indications of the present disclosure.

Those skilled in the art are also capable of adapting the operation of reading systems 500 and 600 to the case where the periodic structures of the Fano resonance filters 203 of marking label 100 are made of a phase-change material. In this case, two successive reading phases respectively corresponding to the two states—amorphous and crystalline—of the phase-change material may be implemented to detect the presence of the Fano resonance filters 203 in marking label 100.

1. An optical marking label, comprising:
a plurality of elementary cells;
wherein one or more first elementary cells of the plurality of elementary cells each comprise at least one Fano resonance filter formed by a periodic structure made of a phase-change material.

2. The label according to claim 1, wherein the periodic structure comprises an array of pads.

3. The label according to claim 1, wherein said one or more first elementary cells each comprise a single Fano resonance filter.

4. The label according to claim 1, wherein said one or more first elementary cells comprise a plurality of first elementary cells with Fano resonance filters having different central frequencies.

5. The label according to claim 1, wherein said one or more first elementary cells each comprise a stack of at least two Fano resonance filters having different central frequencies.

6. The label according to claim 1, wherein said plurality of elementary cells further comprise one or more second elementary cells, wherein each second elementary cell is devoid of a Fano resonance filter.

7. A device for reading an optical marking label comprising a plurality of elementary cells, wherein one or more first elementary cells of the plurality of elementary cells each comprise at least one Fano resonance filter formed by a periodic structure made of a phase-change material, the device comprising:
a light sensor comprising one or a plurality of pixels arranged inside and on top of a semiconductor substrate, each pixel comprising a first photodetector comprising a Fano resonance filter, wherein a central frequency or frequencies of the Fano resonance filter(s) of the light sensor are substantially equal to a central frequency or frequencies of the Fano resonance filter(s) of the optical marking label; and
a source of white light configured to illuminate the optical marking label.

8. The device according to claim 7, wherein each pixel of the light sensor further comprises a second photodetector devoid of a Fano resonance filter.

9. The device according to claim 7, wherein the light sensor further comprises at least one anode region common to a plurality of pixels.

10. The device according to claim 7, wherein the Fano resonance filter of the first photodetector comprises a periodic structure comprising an array of pads.

11. A device for reading an optical marking label comprising a plurality of elementary cells, wherein one or more first elementary cells of the plurality of elementary cells each comprise at least one Fano resonance filter formed by a periodic structure made of a phase-change material, the device comprising:
a visible image sensor intended to capture an image of the optical marking label; and
a light source configured to illuminate the label, the light source comprising one or a plurality of elementary sources, wherein a central emission frequency or frequencies of the elementary source(s) are substantially equal to a central frequency or frequencies of the Fano resonance filter(s) of the optical marking label.

12. A system, comprising:
an optical marking label comprising a plurality of elementary cells, wherein one or more first elementary cells of the plurality of elementary cells each comprise at least one Fano resonance filter formed by a periodic structure made of a phase-change material; and
a device for reading an optical marking label, comprising:
a light sensor comprising one or a plurality of pixels arranged inside and on top of a semiconductor substrate, each pixel comprising a first photodetector comprising a Fano resonance filter, wherein a central frequency or frequencies of the Fano resonance filter(s) of the light sensor are substantially equal to a central frequency or frequencies of the Fano resonance filter(s) of the optical marking label; and
a source of white light configured to illuminate the optical marking label.

13. A method of reading an optical marking label comprising a plurality of elementary cells, wherein one or more first elementary cells of the plurality of elementary cells each comprise at least one Fano resonance filter formed by a periodic structure made of a phase-change material, the method comprising:
a) illuminating the optical marking label by means of a source of white light; and
b) detecting, by means of a light sensor, presence of the Fano resonance filter(s) in the optical marking label by comparing an output signal of the photodetector of each pixel with a reference signal.

14. A method of reading an optical marking label comprising a plurality of elementary cells, wherein one or more first elementary cells of the plurality of elementary cells each comprise at least one Fano resonance filter formed by a periodic structure made of a phase-change material, the method comprising:
a) illuminating the optical marking label by successively activating one or a plurality of elementary sources;
b) capturing, by means of a visible image sensor, for each phase of illumination by one of the one or a plurality of elementary sources, a visible image of the optical marking label; and
c) detecting, based on the visible image(s), a presence and/or position of the Fano resonance filter(s) in the optical marking label.
